(19) United States
(12) Patent Application Publication
(10) Pub. No.: US 2006/0107047 A1
(43) Pub. Date: May 18, 2006

(54) Method, device, and system of securely storing data

(76) Inventor: Hagai Bar-El, Rehovot (IL)

Correspondence Address: PEARL COHEN ZEDEK, LLP, 1500 BROADWAY 12TH FLOOR, NEW YORK, NY, 10036, US

(21) Appl. No.: 11/267,106

(22) Filed: Nov. 7, 2005

Related U.S. Application Data
(60) Provisional application No. 60/626,873, filed on Nov. 12, 2004.

(51) Int. Cl. H04L 9/00

(52) U.S. Cl. 713/168

(57) ABSTRACT

Some demonstrative embodiments of the invention include a method, device an/or system of securely storing data, for example, by preventing unauthorized disclosure of the stored data, and/or ensuring the integrity of the stored data. An apparatus able to securely store data may include, according to some demonstrative embodiments of the invention, a secure control configuration, which may include a secure memory to securely store a key; an encryption module to generate an encrypted record by encrypting a data record to be stored using the key; and a controller to generate authentication information for authenticating the integrity of the encrypted record based on the key. The apparatus may also include a storage for storing the encrypted record and the authentication information. Other embodiments are described and claimed.

### BACKGROUND OF THE INVENTION

Conventional methods for preventing unauthorized disclosure of data may implement various cryptographic ciphers, e.g., a cipher according to the Advanced Encryption Standard (AES), to encrypt the data. The encrypted data may be decrypted by an authorized user using a secret key.

Unfortunately, such conventional methods may not provide sufficient protection against unauthorized manipulation of the data and/or the ability to detect such manipulation in certain situations. For example, the encrypted data may be replaced without authorization, e.g., in its entirety, by a previous version of the encrypted data. The authorized user may not be able to detect such a replacement, and may unknowingly treat the previous version of the data as being the current version. Furthermore, in such methods the secret key may be internally stored, e.g., on a device used for storing the encrypted data, or may be provided by the user. If internally stored, the secret key may be uncovered without authorization, e.g., by reverse engineering. Conversely, if the secret key is to be provided by the user, a device using the protection mechanism may have limited “transparency” with respect to other applications and/or may be able to store only limited types of data. For example, such devices may not be applicable for storing data not owned by the user having the secret key, e.g., because the user may deliberately change the data, e.g., using the secret key.

Conventional devices for securely storing data may include a “physical” protection structure to prohibit any access to the stored data. However, such protection structure may be relatively complex and/or expensive and, thus, may not provide cost-effective protection for large amounts of data.

### SUMMARY OF SOME DEMONSTRATIVE EMBODIMENTS OF THE INVENTION

Some demonstrative embodiments of the invention include a method, device and/or system of securely storing data, for example, by preventing unauthorized disclosure of the stored data, and/or ensuring the integrity of the stored data.

An apparatus able to securely store data may include, according to some demonstrative embodiments of the invention, a secure control configuration, which may include a secure memory to securely store a key; an encryption module to generate an encrypted record by encrypting a data record to be stored using the key; and a controller to generate authentication information for authenticating the integrity of the encrypted record based on the key. The apparatus may also include a storage module for storing the encrypted record and the authentication information.

According to some demonstrative embodiments of the invention, a capacity of the storage may be substantially large compared to a capacity of the secure memory. For example, the capacity of the storage may be at least one hundred times bigger than the capacity of the secure memory.

According to some demonstrative embodiments of the invention, the capacity of the secure memory may be, for example, no more than 10 Kilobytes.

According to some demonstrative embodiments of the invention, the secure memory may be, or may include, an electronically erasable programmable read only memory, a one-time programmable memory, or a memory implemented by one or more fuses; and/or the storage may be, or may include, a flash memory.

According to some demonstrative embodiments of the invention, the controller may generate the authentication information by generating one or more message authentication codes based on the key.

According to some demonstrative embodiments of the invention, the controller may generate a group authentication code for authenticating the integrity of a group of records based on a plurality of record authentication codes corresponding to the group of records.

According to some demonstrative embodiments of the invention, the controller may generate a global authentication code for authenticating the integrity of a plurality of groups of records based on a plurality of group authentication codes corresponding to the plurality of groups. In other demonstrative embodiments of the invention, the global authentication code may relate to one group.

According to some demonstrative embodiments of the invention, the encryption module may also decrypt a stored record. The controller may selectively provide access to the decrypted record based on at least one of an authentication of the integrity of the stored record, an authentication of the integrity of a group of records including the stored record, an authentication of a set of groups including the group of records, and a determination whether the stored record is up-to-date. The controller may deny access to the decrypted record if, for example, the stored record, the integrity of the group of records, and/or the integrity of the set of groups is not authenticated; and/or if the stored record is determined not to be up-to-date. The controller may provide access to the decrypted record if, for example, the integrity of the stored record is authenticated, the stored record is determined to be up-to-date, and at least one of the integrity of the group of records, and the integrity of the set of groups is authenticated.

According to some demonstrative embodiments of the invention, the controller may determine a record authentication code corresponding to a stored record based on the key and a stored initialization vector corresponding to the stored record, and to authenticate the integrity of the stored record by comparing the determined record authentication code to a stored record authentication code corresponding to the stored record.

According to some demonstrative embodiments of the invention, the controller may determine a group authentication code corresponding a stored group of records based on the key and a plurality of stored record authentication codes corresponding to records of the group, and to authenticate the integrity of the group by comparing the determined group authentication code to a stored group authentication code corresponding to the group.

According to some demonstrative embodiments of the invention, the controller may determine a global authentication code of a set of groups of stored records based on the key and a plurality of stored group authentication codes corresponding to the set of groups, and to authenticate the integrity of the set of groups by comparing the determined global authentication code to a stored global authentication code corresponding to the set of groups.

According to some demonstrative embodiments of the invention, the controller may securely store in the memory, version information indicative of a version of one or more records stored in the storage. For example, the controller may securely store in the memory a global authentication code corresponding to a set of groups including the one or more stored records. In another example, the storage may store a counter; and the controller may update the counter when storing a record, and to securely store in the memory a value of the counter. The controller may determine if the one or more stored records are up-to-date, for example, by comparing the securely stored version information to corresponding version information stored in the storage.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features and advantages thereof, may best be understood by reference to the following detailed description when read with the accompanied drawings in which:

FIG. 1 is a schematic block-diagram illustration of a computing platform including a secure storage configuration according to some demonstrative embodiments of the invention;

FIG. 2 is a schematic illustration of a flow chart of a method of securely storing data according to some demonstrative embodiments of the invention; and

FIG. 3 is a schematic illustration of a flow chart of a method of retrieving securely stored data according to some demonstrative embodiments of the invention.

It will be appreciated that for simplicity and clarity of illustration, elements shown in the drawings have not necessarily been drawn accurately or to scale. For example, the dimensions of some of the elements may be exaggerated relative to other elements for clarity or several physical components included in one functional block or element. Further, where considered appropriate, reference numerals may be repeated among the drawings to indicate corresponding or analogous elements. Moreover, some of the blocks depicted in the drawings may be combined into a single function.

### DETAILED DESCRIPTION OF EMBODIMENTS OF THE INVENTION

In the following detailed description, numerous specific details are set forth in order to provide a thorough understanding of the invention. However, it will be understood by those of ordinary skill in the art that the present invention may be practiced without these specific details. In other instances, well-known methods, procedures, components and circuits may not have been described in detail so as not to obscure the present invention.

It will be appreciated that the term “preventing unauthorized disclosure of stored data” as used herein may refer to ensuring the stored data may not be understood without authorization, for example, even if complete access, e.g., partial or complete physical and/or electronic access, to the stored data is obtained. The term “ensuring the integrity of the stored data” as used herein may refer to ensuring that the stored data, in part or in whole, has not been manipulated, altered, tampered with, and/or replaced by other data, for example, without authorization and/or in a way which may not be detected, e.g., at a high probability, by an authorized user.

It will be appreciated that the term “securely storing data” as used herein may refer to preventing unauthorized disclosure of the stored data and/or ensuring the integrity of the stored data.

Some demonstrative embodiments of the invention include a method, device and/or system of securely storing data, as described below.

Part of the discussion herein may relate, for demonstrative purposes, to securely storing a data record (“record”). However, embodiments of the invention are not limited in this regard, and may include, for example, securely storing a data block, a data portion, a data sequence, a data frame, a data field, a content, an item, a message, a key, a code, or the like.

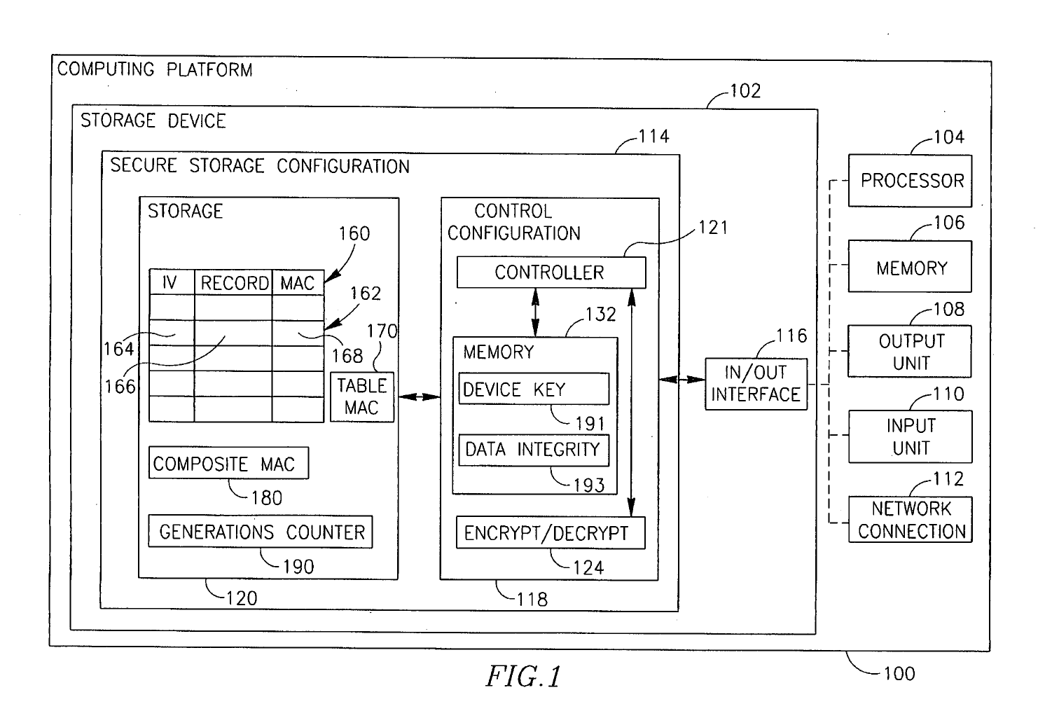

Reference is made to FIG. 1, which schematically illustrates a computing platform 100 according to some demonstrative embodiments of the invention.

Although the present invention is not limited in this respect, computing platform 100 may be a portable device. Non-limiting examples of such portable devices include mobile telephones, laptop and notebook computers, personal digital assistants (PDA), memory cards, memory units, and the like. Alternatively, the computing platform may be a non-portable device, such as, for example, a desktop computer.

According to the demonstrative embodiments of FIG. 1, computing platform 100 may include a securable storage device 102, as described below. Platform 100 may additionally include a processor 104, a memory 106, and, optionally, an output unit 108, an input unit 110, a network connection 112, and/or any other suitable hardware components and/or software components.

According to some demonstrative embodiments of the invention, processor 104 may include a Central Processing Unit (CPU), a Digital Signal Processor (DSP), a microprocessor, a host processor, a plurality of processors, a controller, a chip, a microchip, or any other suitable multi-purpose or specific processor or controller. Input unit 110 may include, for example, a keyboard, a mouse, a touch-pad, or other suitable pointing device or input device. Output unit 108 may include, for example, a Cathode Ray Tube (CRT) monitor, a Liquid Crystal Display (LCD) monitor, or other suitable monitor or display unit. Memory 106 may include, for example, a Random Access Memory (RAM), a Read Only Memory (ROM), a Dynamic RAM (DRAM), a Synchronous DRAM (SD-RAM), a Flash memory, a volatile memory, a non-volatile memory, a cache memory, a buffer, a short term memory unit, a long term memory unit, or other suitable memory units or storage units. Network connection 112 may be adapted to interact with a communication network, for example, a local area network (LAN), wide area network (WAN), or a global communication network, for example, the Internet. According to some embodiments the communication network may include a wireless communication network such as, for example, a wireless LAN (WLAN) communication network. Although the scope of the present invention is not limited in this respect, the communication network may include a cellular communication network, with platform 100 being, for example, a base station, a mobile station, or a cellular handset. The cellular communication network, according to some embodiments of the invention, may be a 3^{rd} Generation Partnership Project (3GPP), such as, for example, Frequency Domain Duplexing (FDD), Global System for Mobile communications (GSM), Wideband Code Division Multiple Access (WCDMA) cellular communication network and the like.

Although the present invention is not limited in this respect, storage device 102 may be a portable storage device, e.g., a portable memory card, disk, chip, and/or any other portable storage device, which may be, for example, detachable from computing platform 100. According to other embodiments, storage arrangement 102 may be a non-portable storage device, for example, a memory card, disk, chip and/or any other storage unit or element integrally connected to computing platform 100.

According to demonstrative embodiments of the invention, storage device 102 may include a secure storage configuration 114 adapted to securely store data, e.g., one or more records received from processor 104, memory 106, input unit 110, network connection 112 and/or any other suitable component of platform 100 and/or associated with platform 100, e.g., internally or externally, as described below.

According to demonstrative embodiments of the invention, secure storage 114 may include a storage module 120 and a protected control configuration 118.

According to demonstrative embodiments of the invention, control configuration 118 may include any suitable protection mechanism, e.g., any suitable “physical” protection structure and/or any other suitable protection configuration as is known in the art, to prevent the disclosure of any part of the contents of configuration 118, to prevent any attempt to access any part of the contents of configuration 118, to prevent any attempt to tamper or alter the contents of configuration 118, in part or in whole, and/or to prevent any attempt to interfere with the operation of configuration 118.

According to demonstrative embodiments of the invention, configuration 118 may be able to receive a record to be stored in storage module 120 and provide storage module 120 with an encrypted record, as described below. Configuration 118 may also be able to decrypt an encrypted record received from storage module 120, e.g., as described below. Configuration 118 may also be able to verify, e.g., before storing a record in storage module 120 and/or before outputting a record retrieved from storage module 120, that the record and/or any other content of storage module 120 has not been manipulated, altered, tampered with, and/or replaced by other content, e.g., without authorization, as described below.

According to some demonstrative embodiments of the invention, configuration 118 may include a controller 121, a memory 122 and an encryption/decryption module 124.

Memory 122 may include any suitable memory, for example, a non-volatile RAM memory, e.g., an Electronically Erasable Programmable Read Only Memory (EEPROM), a One-Time Programmable (OTP) memory, a memory implemented by one or more fuses, as are known in the art. Memory 122 may be able to store a secret device key 191, for example, including a randomly generated sequence, e.g. a random sequence generated by controller 121, having a predetermined length, e.g., 128 bits. Memory 122 may also store data-integrity information 193, e.g., a “storage signature” value and/or a “generations counter” value, as are described below.

In some demonstrative embodiments of the invention, the capacity of memory 122 may be relatively small. In a non-limiting example, the capacity of memory 122 may be no more than 10 Kilobytes.

Encryption/decryption module 124 may include any suitable hardware and/or software, e.g., an encryption/decryption engine as is known in the art, able to encrypt a record to be stored in storage module 120 or decrypt a record received from storage module 120, e.g., as described below. For example, module 124 may implement an AES-CBC cipher algorithm or any other suitable encryption/decryption algorithms, e.g., as are known in the art.

According to some demonstrative embodiments of the invention, controller 121 may include a CPU, a DSP, a microprocessor, a host processor, a plurality of processors, a chip, a microchip, or any other suitable multi-purpose or specific processor or controller.

According to some demonstrative embodiments of the invention, controller 121 may optionally be able to generate, e.g., randomly, a record Initialization Vector (IV). For example, the record IV may include a block of bits of a predetermined length, e.g., 128 bits, corresponding, for example, to the cipher algorithm implemented by encryption/decryption module 124, e.g., as described below. Controller 121 may optionally be able to generate any other predetermined Initialization Vector (IV), for example, a table IV corresponding to a table of records, and/or a composite IV corresponding to a composite Message Authentication Code (MAC). According to other embodiments of the invention one or more IVs may be generated by any other suitable unit, module or element other than controller 121.

Controller 121 and/or module 124 may be able to derive an authentication key, e.g., a MAC key, for example, from device key 191 and/or any other suitable values and/or parameters, e.g., using a hash algorithm, a block cipher algorithm, a CBC-MAC algorithm and/or any other suitable method as known in the art. Controller 121 and/or module 124 may also be able to calculate a record authentication code, e.g., a record-MAC corresponding, for example, to a record received from storage module 120 or intended to be stored in storage module 120, and optionally to the record IV. Controller 121 and/or module 124 may also calculate one or more other authentication codes or MACs, e.g., a table-authentication code corresponding to two or more record authentication codes of a table stored in storage module 120, and/or a composite authentication code corresponding to one or more table authentication codes and/or other contents of storage module 120, as are described in detail below. Controller 121 and/or module 124 may be able to calculate one or more of the authentication codes, for example, by using the authentication key, e.g., the MAC key, and implementing a suitable authentication algorithm, e.g., an AES-MAC algorithm, or an HMAC algorithm, as is known in the art.

Although some demonstrative embodiments of the invention are described herein with reference to implementing a MAC as an authentication code or key, it will be appreciated by those skilled in the art that the invention is not limited in this respect, and the in other embodiments of the invention any other suitable authentication codes and/or keys may be used.

Some demonstrative embodiments of the invention are described herein with reference to a controller, e.g., controller 121, and an encryption/decryption module, e.g., encryption/decryption module 124, implemented as different elements of a control configuration, e.g., configuration 118. However, it will be appreciated by those skilled in the art that the invention is not limited in this respect, and that in other embodiments of the invention the control configuration may include a module able to perform the functionality of both the controller and the decryption/encryption module.

According to some demonstrative embodiments of the invention, storage module 120 may include, for example, a RAM, a DRAM, a SD-RAM, a Flash memory, or other suitable, e.g., non-volatile, memory or storage.

According to some demonstrative embodiments, storage module 120 may be able to store a relatively large amount of data, e.g., compared to the amount of data that may be stored in protected memory 122. In some demonstrative embodiments of the invention the capacity of storage module 120 may be substantially large compared to the capacity of memory 122. In a non-limiting example, the capacity of storage 120 may be at least one hundred times bigger than the capacity of memory 122.

Although the present invention is not limited in this respect, storage module 120 may be, for example, integrally connected to control configuration 118. According to other embodiments, storage module 120 may be detachable from control configuration 118.

According to some demonstrative embodiments of the invention, storage module 120 may store data in one or more tables 160. Each of tables 160 may include, for example, one or more fields 162, including first, second and third portions, 164, 166 and 168, respectively. In some embodiments, portion 166 may store encrypted records received from configuration 118, and portions 164 and 168 may store an IV and a record-MAC corresponding to the record of portion 164, e.g., as described below. However, it will be appreciated by those skilled in the art that according to other embodiments of the invention, tables 160 may include any suitable configuration of one or more fields for storing data, e.g., authentication code and/or IV data, in any suitable format and/or order, e.g., linked lists of variable lengths. The record authentication code corresponding to a specific record may be used, for example, to ensure the integrity of the specific record, as described below.

According to some demonstrative embodiments of the invention, storage module 120 may optionally store one or more table authentication codes, e.g., table-MACs 170, corresponding to the contents of one or more tables 160, respectively. Controller 121 and/or module 124 may be able to calculate table-MAC 170, for example, when storing one or more records in table 160, or when retrieving or altering one or more records of table 160, e.g., as described below. The table authentication code of a specific table may be calculated, for example, using all the record authentication codes of the specific table. The table authentication codes corresponding to a specific table may be used, for example, to ensure the integrity of the specific table as a whole, as described below.

According to some demonstrative embodiments of the invention, storage module 120 may also include a generations counter 190, for example, having a predetermined length, e.g., a length of 128 bits, or any other length. Counter 190 may include or may be any suitable counter or counter-like, e.g., a grey counter. The value stored in generations counter 190 may be modified, for example, incremented, e.g., by one, when storing one or more records in storage module 120, or when altering one or more records of storage module 120, e.g., as described below. According to other demonstrative embodiments, storage module 120 may not implement generations counter 190. In such embodiments, other update-verification information, e.g., a storage-signature value, may be used to verify the contents of storage module 120 are up to date, e.g., as described below.

According to some demonstrative embodiments of the invention, storage module 120 may also store a composite authentication code, e.g., composite-MAC 180, for example, corresponding to the entire contents of storage module 120, e.g., including all the table authentication codes and, optionally, the value of generations counter 190, e.g., if it is implemented. The composite authentication code may be calculated, for example, using, e.g., all the table authentication codes; or using all the record authentication codes, e.g., if only one table is implemented. Controller 121 may be able to calculate composite-MAC 180, for example, when storing one or more records in storage module 120, or when altering one or more records of storage module 120, e.g., as described below. The composite authentication code may be used, for example, to ensure the integrity of the entirety of storage module 120, e.g., as described below. According to some embodiments of the invention, storage 120 may additionally or alternatively include any other suitable data integrity information, e.g., one or more table IVs and/or a composite IV.

According to some demonstrative embodiments of the invention, storage arrangement 102 may additionally include an input/output interface 116 able to receive, e.g., from processor 104, memory 106, input unit 110 and/or network connection 112, data to be stored in storage module 120, and to provide the data to controller 118 in a suitable format. Interface 116 may also be able to receive from controller 118 data which was stored in storage module 120, and provide the data to processor 104, memory 106, output unit 108 and/or network connection 112 in a suitable format. Interface 116 may include any suitable hardware and/or software, e.g., as known in the art.

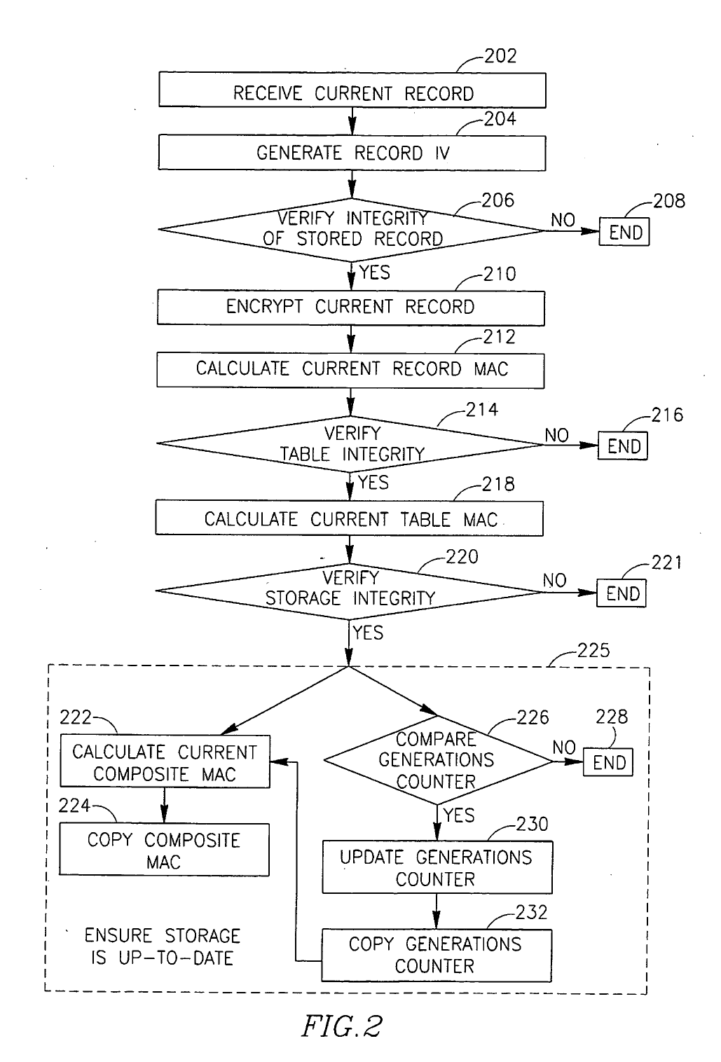

Reference is also made to FIG. 2, which schematically illustrates a method of securely storing data according to some demonstrative embodiments of the invention.

Although the present invention is not limited in this respect, the method of FIG. 2 may be implemented by controller 121, e.g., when attempting to store one or more records in storage module 120.

According to demonstrative embodiments of the invention, the method may include receiving a record to be stored (“the current record”), as indicated at block 202. For example, control configuration 118 may receive, e.g., from interface 116, a record intended for storing in storage module 120.

As indicated at block 204, the method may optionally include generating a record IV and storing the generated record IV at a portion of a field intended to store the current record in storage module 120. For example, controller 121 may generate the record IV and may store the record IV in portion 164 of table 160.

According to some demonstrative embodiments of the invention, the current record may be intended to replace part of, or the entirety of a record currently stored in storage module 120 (“the stored record”), e.g., in at least part of portion 166. As indicated at block 206, according to these demonstrative embodiments, the method may optionally include verifying the integrity of the stored record. Verifying the integrity of the stored record may include, for example, calculating the record authentication code of the stored record, for example, using the corresponding stored record-IV and a secret key, e.g., key 191, and determining whether the calculated record authentication code matches the record authentication code stored in portion 168 (“the stored record authentication code”). A mismatch between the calculated record authentication code and the stored record authentication code may indicate that the stored record has been altered, replaced, or tampered with, e.g., without authorization, at some point in time after the record was originally stored. Thus, as indicated at block 208, the method may include preventing, e.g., denying, stopping, or canceling, the device from storing of the current record if the calculated record authentication code does not match the stored record authentication code.

As indicated at block 210, the method may include encrypting the current record. For example, encryption/decryption module 124 may encrypt the current record using a secret key, e.g., device key 191 or any other suitable secret key and, optionally, the record-IV generated by controller 121.

As indicated at block 212, the method may include calculating a current record authentication code corresponding to the current encrypted record or the current record and, optionally, to the record-IV and, e.g., using the authentication code key as described above. Controller 121 may store the current record authentication code in portion 168. According to some demonstrative embodiments of the invention, calculating the current record authentication code may be performed after encrypting the current record, e.g., as illustrated in FIG. 2. However, it will be appreciated by those skilled in the art that according to other embodiments of the invention calculating the current record authentication code may be performed before encrypting the current record.

As indicated at block 214, the method may optionally include verifying the integrity of the table including the stored record (“the stored table”). Verifying the integrity of the stored table may include, for example, calculating the table authentication code (“the calculated table authentication code), e.g., corresponding to the stored record authentication code and all other record authentication codes of the stored table; and determining whether the calculated table authentication code matches the table authentication code currently stored in storage module 120 (“the stored table authentication code”). A mismatch between the calculated table authentication code and the stored table authentication code may indicate that the stored table has been altered, replaced, or tampered with, in part or in whole, e.g., without authorization, at some point after originally storing the record. Thus, as indicated at block 216, the method may include denying, e.g., stopping, preventing or canceling, further access to the stored table and/or not updating the table authentication code of the stored table, for example, if the calculated table authentication code does not match the stored table authentication code.

As indicated at block 218, if the calculated table authentication code matches the stored table authentication code, then the method may also include calculating a current table authentication code, e.g., using the current record authentication code and other record authentication codes of the stored table, and replacing the stored table authentication code with the current table authentication code.

According to other embodiments of the invention, it may not be required to implement a table authentication code, for example, if storage module 120 includes only one table. In such a case, for example, verifying the composite authentication code of the storage module, e.g., previously calculated using one or more, e.g., all, of the record authentication codes, may be sufficient to verify that the contents of the single table has not been altered, replaced or tampered with, in part or in whole, e.g., without authorization.

As indicated at block 220, the method may also include verifying the integrity of storage module 120. Verifying the integrity of storage module 120 may include, for example, calculating the composite authentication code (“the calculated composite authentication code), e.g., corresponding to the stored table authentication code and all other table authentication codes and/or the value stored in generations counter 190, and determining whether the calculated composite authentication code matches the composite authentication code currently stored in storage module 120 (“the stored composite authentication code”). A mismatch between the calculated composite authentication code and the stored composite authentication code may indicate that the contents of storage module 120 has been altered, replaced, or tampered with, in part or in whole, e.g., without authorization. Thus, as indicated at block 221, the method may include stopping or denying any further access to the composite authentication code and/or not updating the composite authentication code, e.g., if the calculated composite authentication code does not match the stored composite authentication code.

It is appreciated that an attack, e.g., by an unauthorized user, may include replacing the entire contents of storage module 120 with content previously stored in storage module 120. Such an attack may not be discovered by verifying the integrity of the record, the tables and/or the entirety of storage module 120.

Thus, as indicated at block 225, according to some demonstrative embodiments of the invention the method may also include ensuring the contents of storage module 120 are properly and fully up-to-date, i.e., ensuring storage module 120 includes the data most recently stored with authorization, for example, if the calculated composite authentication code matches the stored composite authentication code.

As indicated at block 226, ensuring the contents of storage module 120 are up-to-date may include, according to some demonstrative embodiments of the invention, comparing the value of generations counter 190 with the generations counter value stored in memory 122 of control configuration 118, e.g., the generations counter value of data-integrity information 193.

As indicated at block 230, the method may also include changing the generations counter value, e.g., if a comparison between generations counter value of storage module 120 and the generations counter value of memory 122 indicates the contents of storage module 120 are up-to-date. For example, the generations counter value may be incremented, e.g., by one, if the generations counter value of storage module 120 is equal to or bigger than the generations counter value of memory 122.

As indicated at block 232, the method may also include copying the updated generations counter value to memory 122. According to other embodiments the generations counter value may be updated according to any other predetermined updating scheme, e.g., such that the generations counter value is updated only for some of the instances when a record is stored or modified in storage module 120.

As indicated at block 222, ensuring the contents of storage module 120 are up-to-date may include calculating a current composite authentication code, for example, using the current table authentication code, other table authentication codes or record authentication codes of the stored table, and optionally the updated generations counter value, e.g., if applicable in a given context, and replacing the stored composite authentication code with the current composite authentication code. According to some embodiments, e.g., wherein ensuring the contents of storage module 120 are properly and fully up-to-date includes using the generations counter as described above, the generations counter value may be updated before calculating the composite authentication code, and calculating the composite authentication code may include using the updated generations counter value.

As indicated at block 224, according to other demonstrative embodiments of the invention, ensuring the contents of storage module 120 are up-to-date may include copying the current composite authentication code to memory 122 as data integrity information 193, e.g., if the generations counter is not implemented.

It will be appreciated by those skilled in the art that the above operations, e.g., if performed in the above order, may provide efficient protection against some race-condition attacks, i.e., attacks performed during a time period wherein two or more processes interfere which each other, since the different integrity verification operations are not grouped together, e.g., at the beginning of the process, and/or the different storing operations are not grouped together. However, it will be appreciated by those skilled in the art that any combination of the above actions may be implemented for securely storing data according to embodiments of the invention. Further, other actions or series of actions may be used.

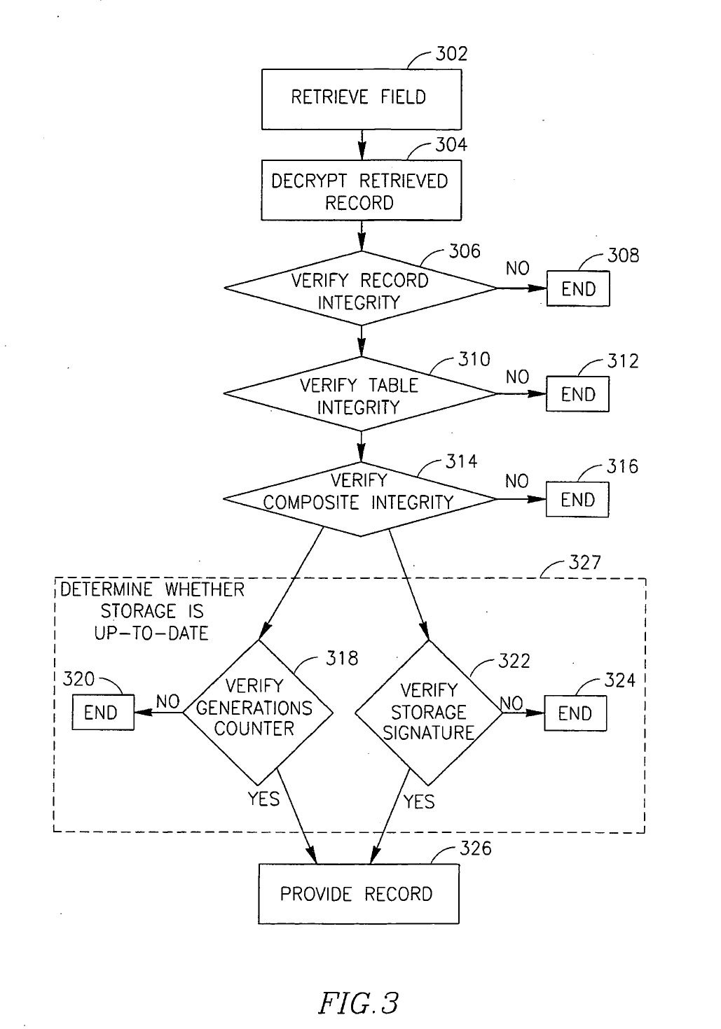

Reference is also made to FIG. 3, which schematically illustrates a method of retrieving securely stored data according to some demonstrative embodiments of the invention.

Although the present invention is not limited in this respect, the method of FIG. 3 may be implemented by controller 121, e.g., when retrieving one or more records from storage module 120.

As indicated at block 302, the method may include retrieving, e.g., from storage module 120, a field including an encrypted record. For example, controller 121 may retrieve field 162 having portion 166 including the encrypted record, and portions 164 and 168 including the corresponding record-IV and stored record authentication code, respectively.

As indicated at block 304, the method may include decrypting the retrieved record, e.g., using device key 191 and, optionally, the retrieved record-IV.

As indicated at block 306, the method may also include verifying the integrity of the retrieved record. Verifying the integrity of the retrieved record may include, for example, calculating the record authentication code corresponding to the retrieved record and, optionally, the retrieved record-IV, and comparing the calculated record authentication code with the retrieved record authentication code.

As indicated at block 308, the method may include stopping, canceling, or denying the transfer of the encrypted retrieved record to interface 116, e.g., if the calculated record authentication code does not match the retrieved record authentication code.

As indicated at block 310, the method may also include verifying the integrity of the table (“the current table”) from which the record was retrieved. Verifying the integrity of the current table may include, for example, retrieving from storage module 120 the table authentication code corresponding to the current table, calculating the table authentication code corresponding to the record authentication codes of the current table, and comparing the calculated table authentication code with the retrieved table authentication code.

As indicated at block 312, the method may include stopping, canceling, or denying the transfer of the encrypted retrieved record to interface 116, e.g., if the calculated table authentication code does not match the table authentication code stored in storage module 120.

As indicated at block 314, the method may also include verifying the integrity of storage module 120. Verifying the integrity of storage module 120 may include, for example, calculating the composite authentication code of storage module 120, e.g., corresponding to the table authentication codes of storage module 120 and, optionally, the generations counter of storage module 120; and comparing the calculated composite authentication code with the composite authentication code stored in storage module 120.

As indicated at block 316, the method may include stopping, canceling, or denying the transfer of the encrypted retrieved record to interface 116, e.g., if the calculated composite authentication code does not match the composite authentication code stored in storage module 120.

As indicated at block 327, the method may also include determining whether the contents of storage module 120 are up-to-date.

As indicated at block 318, according to some demonstrative embodiments of the invention, determining whether the contents of storage module 120 are up-to-date may include comparing generations counter value 190 of storage module 120 with the generations counter value stored in memory 122 of control configuration 118, e.g., the generations counter value of data-integrity information 193.

As indicated at block 320, the method may include stopping, canceling, or denying the transfer of the encrypted retrieved record to interface 116, for example, if the generations counter value of storage module 120 is smaller than the generations counter value stored in memory 122, e.g., the generations counter value of data-integrity information 193.

As indicated at block 322, according to other demonstrative embodiments of the invention, determining whether the contents of storage module 120 are up-to-date may include comparing the storage signature value stored in memory 122, e.g., as data integrity information 193, with composite-MAC 180.

As indicated at block 324, the method may include stopping, canceling, or denying the transfer of the encrypted retrieved record to interface 116, e.g., if the storage-signature stored as data integrity information 193 is not equal to composite-MAC180.

As indicated at block 326, the method may also include providing the decrypted record, e.g., to interface 116, for example, if the record integrity is verified, the table integrity is verified, the integrity of storage module 120 is verified and storage module 120 is determined to be up to date.

Embodiments of the present invention may be implemented by software, by hardware, or by any combination of software and/or hardware as may be suitable for specific applications or in accordance with specific design requirements. Embodiments of the present invention may include units and sub-units, which may be separate of each other or combined together, in whole or in part, and may be implemented using specific, multi-purpose or general processors, or devices as are known in the art. Some embodiments of the present invention may include buffers, registers, storage units and/or memory units, for temporary or long-term storage of data and/or in order to facilitate the operation of a specific embodiment.

While certain features of the invention have been illustrated and described herein, many modifications, substitutions, changes, and equivalents may occur to those of ordinary skill in the art. It is, therefore, to be understood that the appended claims are intended to cover all such modifications and changes as fall within the true spirit of the invention.

What is claimed is:

1. An apparatus of securely storing data, the apparatus comprising:
a secure control configuration comprising:
a secure memory to securely store a key;
an encryption module to generate an encrypted record by encrypting a data record to be stored using said key; and
a controller to generate authentication information for authenticating the integrity of said encrypted record based on said key; and
a storage for storing said encrypted record and said authentication information.

2. The apparatus of claim 1, wherein said controller is able to generate a group authentication code for authenticating the integrity of a group of records based on a plurality of record authentication codes corresponding to said group of records.

3. The apparatus of claim 2, wherein said controller is able to generate a global authentication code for authenticating the integrity of a plurality of groups of records based on a plurality of group authentication codes corresponding to said plurality of groups.

4. The apparatus of claim 1, wherein said encryption module is able to decrypt a stored record, and wherein said controller is able to selectively provide access to the decrypted record based on at least one of an authentication of the integrity of said stored record, an authentication of the integrity of a group of records including said stored record, an authentication of a set of groups including said group of records, and a determination whether said stored record is up-to-date.

5. The apparatus of claim 4, wherein said controller is able to deny access to said decrypted record if at least one of the integrity of said stored record, the integrity of said group of records, and the integrity of said set of groups is not authenticated.

6. The apparatus of claim 4, wherein said controller is able to deny access to said decrypted record if said stored record is determined not to be up-to-date.

7. The apparatus of claim 4, wherein said controller is able to provide access to said decrypted record if the integrity of said stored record is authenticated, said stored record is determined to be up-to-date, and at least one of the integrity of said group of records, and the integrity of said set of groups is authenticated.

8. The apparatus of claim 1, wherein said controller is able to determine a record authentication code corresponding to a stored record based on said key, and to authenticate the integrity of said stored record by comparing the determined record authentication code to a stored record authentication code corresponding to said stored record.

9. The apparatus of claim 1, wherein said controller is able to determine a group authentication code corresponding a stored group of records based on said key and a plurality of stored record authentication codes corresponding to records of said group, and to authenticate the integrity of said group by comparing the determined group authentication code to a stored group authentication code corresponding to said group.

10. The apparatus of claim 1, wherein said controller is able to determine a global authentication code of a set of groups of stored records based on said key and a plurality of stored group authentication codes corresponding to said set of groups, and to authenticate the integrity of said set of groups by comparing the determined global authentication code to a stored global authentication code corresponding to said set of groups.

11. The apparatus of claim 1, wherein said controller is able to securely store in said secure memory version information indicative of a version of one or more records stored in said storage.

12. The apparatus of claim 11, wherein said controller is able to securely store in said secure memory a global authentication code corresponding to a set of groups including said one or more stored records.

13. The apparatus of claim 11, wherein said storage is able to store a counter, and wherein said controller is able to update said counter when storing a record, and to securely store in said memory a value of said counter.

14. The apparatus of claim 11, wherein said controller is able to determine if said one or more stored records are up-to-date by comparing the securely stored version information to corresponding version information stored in said storage.

15. The apparatus of claim 1, wherein said secure control configuration is adapted to prevent unauthorized disclosure of the contents of said control configuration, and to prevent unauthorized access to the contents of said control configuration.

16. The apparatus of claim 1, wherein a capacity of said storage is substantially large compared to a capacity of said secure memory.

17. The apparatus of claim 16, wherein the capacity of said storage is at least one hundred times bigger than the capacity of said secure memory.

18. The apparatus of claim 1, wherein the capacity of said secure memory is no more than 10 Kilobytes.

19. The apparatus of claim 1, wherein said secure memory comprises a memory selected from the group consisting of an electronically erasable programmable read only memory, a one-time programmable memory, and a memory implemented by one or more fuses.

20. The apparatus of claim 1, wherein said storage comprises a flash memory.

21. A method of securely storing data, the method comprising:
securely storing a key in a first memory;
generating an encrypted record by encrypting a data record to be stored using said key;
generating authentication information for authenticating the integrity of said encrypted record based on said key; and
storing said encrypted record and said authentication information in a second memory linkable to said first memory.

22. The method of claim 21, wherein generating said authentication information comprises generating a group authentication code for authenticating the integrity of a group of records based on a plurality of record authentication codes corresponding to said group of records.

23. The method of claim 22, wherein generating said authentication information comprises generating a global authentication code for authenticating the integrity of a plurality of groups of records based on a plurality of group authentication codes corresponding to said plurality of groups.

24. The method of claim 21 comprising:
decrypting a stored record; and
selectively providing access to the decrypted record based on at least one of an authentication of the integrity of said stored record, an authentication of the integrity of a group of records including said stored record, an authentication of a set of groups including said group of records, and a determination whether said stored record is up-to-date.

25. The method of claim 24 comprising denying access to said decrypted record if at least one of the integrity of said stored record, the integrity of said group of records, and the integrity of said set of groups is not authenticated.

26. The method of claim 25 comprising denying access to said decrypted record if said stored record is determined not to be up-to-date.

27. The method of claim 25 comprising providing access to said decrypted record if the integrity of said stored record is authenticated, said stored record is determined to be up-to-date, and at least one of the integrity of said group of records, and the integrity of said set of groups is authenticated.

28. The method of claim 21 comprising:
determining a record authentication code corresponding to a record stored in said second memory based on said key; and
authenticating the integrity of said stored record by comparing the determined record authentication code to a stored record authentication code corresponding to said stored record.

29. The method of claim 21 comprising:
determining a group authentication code corresponding a group of records stored in said second memory based on said key and a plurality of stored record authentication codes corresponding to records of said group; and
authenticating the integrity of said group by comparing the determined group authentication code to a stored group authentication code corresponding to said group.

30. The method of claim 21 comprising:
determining a global authentication code of a set of groups of records stored in said second memory based on said key and a plurality of stored group authentication codes corresponding to said set of groups; and
authenticating the integrity of said set of groups by comparing the determined global authentication code to a stored global authentication code corresponding to said set of groups.

31. The method of claim 21 comprising securely storing in said first memory version information indicative of a version of one or more records stored in said second memory.

32. The method of claim 31, wherein securely storing said version information comprises securely storing a global authentication code corresponding to a set of groups including said one or more stored records.

33. The method of claim 31 comprising:
updating a counter when storing a record in said second memory; and
securely storing a value of said counter in said first memory.

34. The method of claim 31 comprising determining if said one or more stored records are up-to-date by comparing said securely stored version information to corresponding version information stored in said second memory in association with said one or more stored records.

35. The method of claim 21, wherein securely storing said key comprises preventing unauthorized disclosure of said key and preventing unauthorized access to said key.

36. The method of claim 21, wherein a capacity of said second memory is substantially large compared to a capacity of said first memory.

37. The method of claim 36, wherein the capacity of said second memory is at least one hundred times bigger than the capacity of said first memory.

38. The method of claim 21, wherein the capacity of said first memory is no more than 10 Kilobytes.

39. The method of claim 21, wherein said first memory comprises a memory selected from the group consisting of an electronically erasable programmable read only memory, a one-time programmable memory, and a memory implemented by one or more fuses.

40. The method of claim 21, wherein said second memory comprises a flash memory.

41. A computing platform comprising:
a secure storage configuration for securely storing data comprising:
a secure control configuration comprising:
a memory to securely store a key;
an encryption module to generate an encrypted record by encrypting a data record to be stored using said key; and
a controller to generate authentication information for authenticating the integrity of said encrypted record based on said key; and
a storage for storing said encrypted record and said authentication information; and
a processor to process one or more securely stored records retrieved from said secure storage configuration.

42. The computing platform of claim 41, wherein said controller is able to generate a group authentication code for authenticating the integrity of a group of records based on a plurality of record authentication codes corresponding to said group of records.

43. The computing platform of claim 41, wherein said encryption module is able to decrypt a stored record, and wherein said controller is able to selectively provide access to the decrypted record based on at least one of an authentication of the integrity of said stored record, an authentication of the integrity of a group of records including said stored record, an authentication of a set of groups including said group of records, and a determination whether said stored record is up-to-date.

44. The computing platform of claim 41, wherein said controller is able to determine a record authentication code corresponding to a stored record based on said key, and to authenticate the integrity of said stored record by comparing the determined record authentication code to a stored record authentication code corresponding to said stored record.

45. The computing platform of claim 41, wherein said controller is able to determine a group authentication code corresponding a stored group of records based on said key and a plurality of stored record authentication codes corresponding to records of said group, and to authenticate the integrity of said group by comparing the determined group authentication code to a stored group authentication code corresponding to said group.

46. The computing platform of claim 41, wherein said controller is able to determine a global authentication code of a set of groups of stored records based on said key and a plurality of stored group authentication codes corresponding to said set of groups, and to authenticate the integrity of said set of groups by comparing the determined global authentication code to a stored global authentication code corresponding to said set of groups.

47. The computing platform of claim 41, wherein said controller is able to securely store in said memory version information indicative of a version of one or more records stored in said storage.
